(19) United States
(12) Patent Application Publication
(10) Pub. No.: US 2009/0219837 A1
(43) Pub. Date: Sep. 3, 2009

(54) SIGNAL TRANSCEIVE FOR WIRELESS COMMUNICATION DEVICE

(76) Inventors: Chi-Hsien Chiu, Taipei City (TW); Kuo-Chu Liao, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/272,702

(22) Filed: Nov. 17, 2008

(30) Foreign Application Priority Data
Feb. 29, 2008 (TW) 097107082

(51) Int. Cl. H04B 7/00

(52) U.S. Cl. 370/278

(57) ABSTRACT

A signal transceiver for saving the production cost of a wireless communication device includes an antenna, an antenna switch module, a radio frequency (RF) transceiver, an RF front-end circuit, a first selection unit and a second selection unit. The signal transceiver uses the RF front-end circuit unit to meet requirements of multi-band for the wireless communication device through the operation of the first selection unit and the second selection unit to greatly reduce the production cost of the wireless communication device.

### BACKGROUND OF THE INVENTION

1. Field of the Invention

The invention relates to a signal transceiver of a wireless communication device and, more particularly, to a signal transceiver for saving the production cost of a wireless communication device.

2. Description of the Related Art

The wireless communication system rapidly develops recently, and the universal mobile telecommunications system (UMTS) replaces the global system for mobile communications (GSM) to be the mainstream wireless communication system. The wireless communication system utilizes different band in different country. Taking the GSM as an example, it utilizes the bands of 850 MHz and 1900 MHz in North America, and it utilizes the bands of 900 MHz and 1800 MHz in Europe. Taking the UMTS as an example, it utilizes the bands of 850 MHz and 1900 MHz in North America, and it utilizes the band of 2100 MHz in Europe. Since the wireless communication system utilizes different band in different country, when the wireless communication device is designed, in order to sell in different countries and reduce the production cost, a plurality of groups of radio frequency (RF) front-end circuits corresponding to different bands, respectively, are designed in the RF transceiver of the wireless communication device.

FIG. 1 is a schematic diagram showing a conventional signal transceiver 10. As shown in FIG. 1, the signal transceiver 10 includes a RF transceiver 100, a first RF front-end circuit 102, a second RF front-end circuit 104, an antenna switch module (ASM) 106 and an antenna 108. The RF transceiver 100 is coupled to the first RF front-end circuit 102 and the second RF front-end circuit 104 and includes a plurality of signal transmitting terminals and a plurality of signal receiving terminals, and it is used to modulate, demodulate, synthesize and mix a RF signal. The first RF front-end circuit 102 and the second RF front-end circuit 104 are coupled between the RF transceiver 100 and the ASM 106, and they are two different circuits used in different bands and having components that are similar in function but different in standard. The first RF front-end circuit 102 and the second RF front-end circuit 104 are used to perform a filter function, a power amplifier function, a coupling function and a duplex function on the RF signal. The ASM 106 is coupled to the first RF front-end circuit 102, the second RF front-end circuit 104 and the antenna 108 and includes a plurality of duplex transmission terminals. According to the operating band of the wireless communication device, one of the duplex transmission terminals of the ASM 106 is selected to couple to the antenna 108. The antenna 108 is used to transmit or receive the RF signal.

The first RF front-end circuit 102 and the second RF front-end circuit 104 are illustrated in detail herein below. Taking the first RF front-end circuit 102 as an example, it further includes a RF transmitter 120, a RF receiver 122 and a duplexer 124. The RF transmitter 120 includes a surface acoustic wave (SAW) filter, a power amplifier (PA), a coupler and an isolator and is used to process and transmit the RF signal. The RF receiver 122 includes a SAW filter and a low noise amplifier (LNA) and is used to receive and process the RF signal. The duplexer 124 is used to switch to transmit and receive the RF signal. The first RF front-end circuit 102 and the second RF front-end circuit 104 are two different groups of RF front-end circuit that are used under different bands. For example, if the wireless communication device using the signal transceiver 10 is intended to be sold to North America or Europe, the assembly of the first RF front-end circuit 102 is designed to operate under the band of 850 MHz, and the assembly of the second RF front-end circuit 104 is designed to operate under the band of 2100 MHz. The assemblies of the first RF front-end circuit 102 and the second RF front-end circuit 104 are pre-set on a circuit board, and the supplier of the wireless communication device can determine to use the assembly of the first RF front-end circuit 102 or the assembly of the second RF front-end circuit 104 according to the band used in different sales territory.

Taking a mobile phone as an example, to meet the miniaturization and multi-function tendency, the area of circuit layout becomes smaller and smaller, and the production cost becomes higher and higher. Since the cost of the assembly of the RF front-end circuit is high, the mode of pre-setting a plurality of groups of RF front-end circuit cannot reduce the area of circuit layout and the volume of the product, wastes the production cost and cannot make the product maintain the competitive power on the market.

### BRIEF SUMMARY OF THE INVENTION

The objective of the invention is to provide a signal transceiver for saving the cost of a wireless communication device.

The invention discloses a signal transceiver for a wireless communication device and for saving the area of circuit layout and reducing the cost. The signal transceiver includes an antenna, an antenna switch module (ASM), a radio frequency (RF) transceiver, a RF front-end circuit, a first selection unit and a second selection unit. The ASM is coupled to the antenna and includes a plurality of duplex transmission terminals. The RF transceiver includes a plurality of signal transmitting terminals and a plurality of signal receiving terminals and is used to generate or process a RF signal via the signal transmitting terminals and the signal receiving terminals. The RF front-end circuit is used to process the RF signal. A first selection unit coupled between the RF transceiver and the RF front-end circuit and used to select a signal transmitting terminal from the signal transmitting terminals and a signal receiving terminal from the signal receiving terminals to couple to the RF front-end circuit according to the operating band of the wireless communication device; and a second selection unit coupled between the RF front-end circuit and the ASM and used to select one duplex transmission terminal from the duplex transmission terminals to couple to the RF front-end circuit according to the operating band of the wireless communication device.

The invention further discloses a signal transceiver for a wireless communication device and for saving the area of circuit layout and reducing the cost. The signal transceiver includes an antenna module, a RF transceiver, a RF front-end circuit and a selection unit. The RF transceiver includes a plurality of signal transmitting terminals and a plurality of signal receiving terminals and is used to generate or process a RF signal via the signal transmitting terminals and the signal receiving terminals. The RF front-end circuit is coupled to the antenna module and used to process the RF signal. A selection unit coupled between the RF transceiver and the RF front-end circuit and used to select a signal transmitting terminal from the signal transmitting terminals and a signal receiving terminal from the signal receiving terminals to couple to the RF front-end circuit according to the operating band of the wireless communication device.

The invention further discloses a signal transceiver for a wireless communication device and for saving the area of circuit layout and reducing the cost. The signal transceiver includes an antenna module, a RF transceiver, a RF front-end circuit and a selection unit. The RF transceiver includes a plurality of signal transmitting terminals and a plurality of signal receiving terminals and is used to generate or process a RF signal via the signal transmitting terminals and the signal receiving terminals. The RF front-end circuit is used to process the RF signal. The selection unit is coupled between the antenna module and the RF front-end circuit and used to select a duplex transmission terminal from the duplex transmission terminals of the antenna module to couple the duplex transmission terminal to the RF front-end circuit according to the operating band of the wireless communication device.

In the invention, the RF front-end circuit meets requirements of a plurality of operating bands for the wireless communication device to greatly reduce the production cost of the wireless communication device.

### BRIEF DESCRIPTION OF THE SEVERAL VIEWS OF THE DRAWINGS

FIG. 1 is a schematic diagram showing a conventional signal transceiver; and

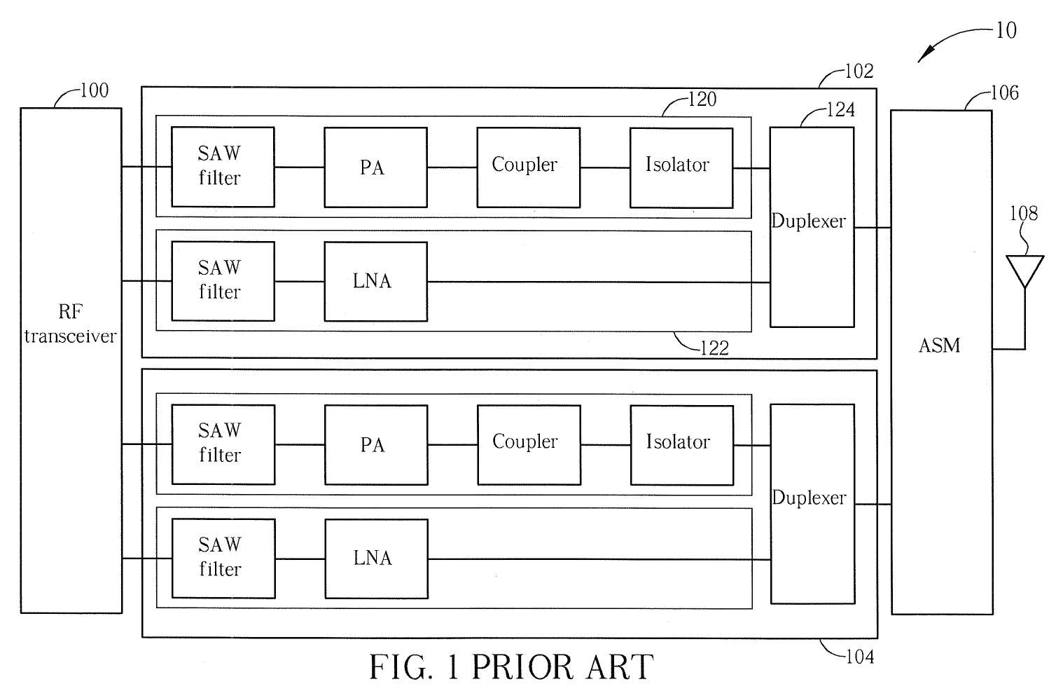

FIG. 2 is a schematic diagram showing a signal transceiver of an embodiment of the invention.

### DETAILED DESCRIPTION OF THE EMBODIMENTS

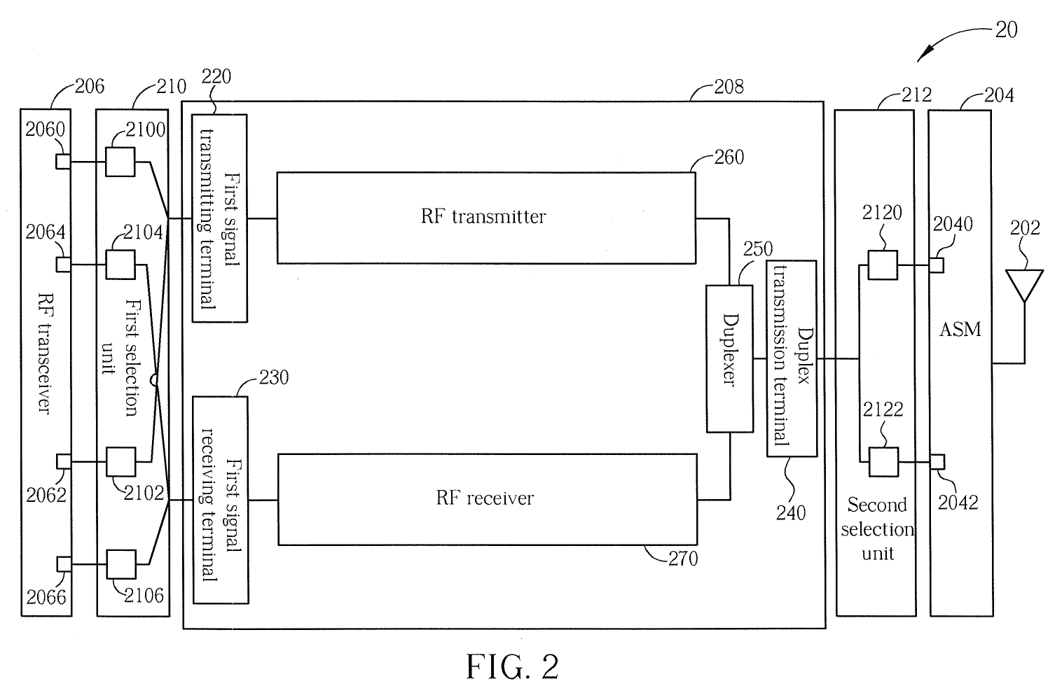

As shown in FIG. 2, FIG. 2 is a schematic diagram showing a signal transceiver 20 for a wireless communication device in an embodiment of the invention. The wireless communication device may be a mobile phone or other electronic device having a wireless communication function. The signal transceiver 20 is used to transmit or receive a radio frequency (RF) signal corresponding to the wireless communication device. For example, the signal transceiver 20 converts a baseband signal to a RF signal and emit the RF signal to the air, or it converts a received RF signal to a baseband signal. The signal transceiver 20 includes an antenna 202, an antenna switch module (ASM) 204, a RF transceiver 206, a RF front-end circuit 208, a first selection unit 210 and a second selection unit 212.

The antenna 202 is coupled to the ASM 204 and used to transmit or receive a RF signal. The ASM 204 is coupled between the antenna 202 and the second selection unit 212 and includes duplex transmission terminals 2040 and 2042. The ASM 204 is used to select one duplex transmission terminal from the duplex transmission terminals 2040 and 2042 to couple to the antenna 202 according to the operating band of the wireless communication device. The RF transceiver 206 is coupled to the first selection unit 210 and includes signal transmitting terminals 2060 and 2062 and signal receiving terminals 2064 and 2066. The RF transceiver 206 is used to modulate, demodulate, synthesize and mix the RF signal. The RF front-end circuit 208 is coupled between the first selection unit 210 and the second selection unit 212 and includes a first signal transmitting terminal 220, a first signal receiving terminal 230, a duplex transmission terminal 240 and other components (illustrated hereinbelow), and it is used to perform a filter function, a power amplifier function, a coupling function and a duplex function on the RF signal. The first selection unit 210 is coupled between the RF transceiver 206 and the RF front-end circuit 208 and includes transmitting switch assemblies 2100 and 2102 and receiving switch assemblies 2104 and 2106. The transmitting switch assemblies 2100 and 2102 are coupled between the signal transmitting terminals 2060 and 2062 and the first signal transmitting terminal 220 and used to set the conduction condition between the corresponding signal transmitting terminal and the first signal transmitting terminal 220 according to the operating band of the wireless communication device. The receiving switch assemblies 2104 and 2106 are coupled between the signal receiving terminals 2064 and 2066 and the first signal receiving terminal 230, respectively, and used to set the conduction condition between the corresponding signal receiving terminal and the first signal receiving terminal 230 according to the operating band of the wireless communication device. The second selection unit 212 is coupled between the antenna module 204 and the RF front-end circuit 208 and includes switch assemblies 2120 and 2122. The switch assemblies 2120 and 2122 are coupled between the duplex transmission terminals 2040 and 2042 and the duplex transmission terminal 240, respectively and used to set the conduction condition between the corresponding duplex transmission terminal and the duplex transmission terminal 240 according to the operating band of the wireless communication device.

The RF front-end circuit 208 is illustrated in detail. The RF front-end circuit 208 includes a duplexer 250, a RF transmitter 260 and a RF receiver 270 besides the first signal transmitting terminal 220, the first signal receiving terminal 230 and the duplex transmission terminal 240. The duplexer 250 is coupled between the RF transmitter 260 and the RF receiver 270 and the duplex transmission terminal 240 and used to switch to transmit or receive the RF signal. The RF transmitter 260 is coupled between the first signal transmitting terminal 220 and a duplexer 250 and used to perform a filter function, a power amplifier function and a coupling function on the RF signal. The RF receiver 270 is coupled between the first signal receiving terminal 230 and the duplexer 250 and used to perform a filter function and a power amplifier function on the RF signal.

The first selection unit 210 can select one signal transmitting terminal from the signal transmitting terminals 2060 and 2062 of the RF transceiver 206 to couple the signal transmitting terminal to the first signal transmitting terminal 220 of the RF front-end circuit 208 and select one signal receiving terminal from the signal receiving terminals 2064 and 2066 of the RF transceiver 206 to couple the signal receiving terminal to the first signal receiving terminal 230 of the RF front-end circuit 208 according to the operating band of the wireless communication device. The second selection unit 212 can select one duplex transmission terminal from the duplex transmission terminals 2040 and 2042 of the ASM 204 to couple the duplex transmission terminal to the duplex transmission terminal 240 of the RF front-end circuit 208 according to the operating band of the wireless communication device. In other words, the signal transceiver 20 only needs to include one group of RF front-end circuit (namely, the RF front-end circuit 208), and it can transmit or receive the RF signal of different operating bands via the switch of the first selection unit 210 and the second selection unit 212. For example, if the wireless communication device using the signal transceiver 20 is intended to be sold to North America, the assemblies of the RF front-end circuit 208 can be designed to operate under the operating band of 850 MHz, or if the wireless communication device using the signal transceiver 20 is intended to be sold to Europe, the assemblies of the RF front-end circuit 208 can be designed to operate under the operating band of 2100 MHz.

FIG. 2 is a schematic diagram showing the signal transceiver 20 of the embodiment of the invention, and persons having ordinary skill in the art can make modification without departing the spirit of the invention. For example, the designer may select to use the first selection unit 210 or the second selection unit 212 only according to a requirement. If only the first selection unit 210 is used, the duplex transmission terminal 240 of the RF front-end circuit 208 is coupled to the duplex transmission terminals 2040 and 2042 of the ASM 204. If only the second selection unit 212 is used, the first signal transmitting terminal 220 of the RF front-end circuit 208 is coupled to the signal transmitting terminals 2060 and 2062 of the RF transceiver 206, and the first signal receiving terminal 230 is coupled to the signal receiving terminals 2064 and 2066 of the RF transceiver 206.

The numbers of the signal transmitting terminals and the signal receiving terminals of the RF transceiver 206 may be changed according to the requirement of the designer, and they are not limited in the invention. The number of the duplex transmission terminals of the ASM 204 also may be changed. Under this condition, the numbers of the switch assemblies of the first selection unit 210 and the second selection unit 212 also can be changed. In FIG. 2, the RF front-end circuit 208 is used to transmit or receive the RF signal, and it can be changed according to the requirement of the designer and is not limited in the invention. In the embodiment of the invention, the signal transceiver 20 can be used under two different bands via the switch of the first selection unit 210 and the second selection unit 212. If the RF transceiver 206 includes three signal transmitting terminals and three signal receiving terminal, and the ASM 204 also includes three duplex transmission terminals, the signal transceiver 20 can be used under three different bands via the switch of the first selection unit 210 and the second selection unit 212, and the rest may be deduced by analogy.

From the above, only the circuit layout and component positions of one group of RF front-end circuit (namely, the RF front-end circuit 208) need to be kept, and the wireless communication device still can be used in different country or area via the switch of the first selection unit 210 and the second selection unit 212 according to the operating band used in different sales territory. Therefore, the embodiment of the invention overcomes faults that the area of circuit layer, the production volume and the production cost cannot be reduced in the conventional technology that a plurality of groups of RF front-end circuit should be designed.

To sum up, in the embodiment of the invention, the first selection unit 210 and the second selection unit 212 are switched to allow the RF front-end circuit 208 to use different assemblies to transmit or receive the RF signals of different bands according to the operating band of the wireless communication device, thereby reducing the area of circuit layout and the production volume and saving the production cost.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A signal transceiver for a wireless communication device, comprising:
an antenna switch module (ASM) including a plurality of duplex transmission terminals;
a radio frequency (RF) transceiver including a plurality of signal transmitting terminals and a plurality of signal receiving terminals, wherein the RF transceiver is used to generate or process a RF signal via the signal transmitting terminals and the signal receiving terminals;
a RF front-end circuit for processing the RF signal;
a first selection unit coupled between the RF transceiver and the RF front-end circuit and used to select a signal transmitting terminal from the signal transmitting terminals and a signal receiving terminal from the signal receiving terminals to couple to the RF front-end circuit according to the operating band of the wireless communication device; and
a second selection unit coupled between the RF front-end circuit and the ASM and used to select one duplex transmission terminal from the duplex transmission terminals to couple to the RF front-end circuit according to the operating band of the wireless communication device.

2. The signal transceiver according to claim 1, wherein the ASM is used to select the duplex transmission terminal from the duplex transmission terminals to couple to an antenna.

3. The signal transceiver according to claim 1, wherein the RF front-end circuit comprises:
a first signal transmitting terminal;
a first signal receiving terminal;
a duplex transmission terminal;
a duplexer coupled to the duplex transmission terminal;
a RF transmitter coupled between the first signal transmitting terminal and the duplexer; and
a RF receiver coupled between the first signal receiving terminal and the duplexer.

4. The signal transceiver according to claim 3, wherein the RF transmitter and the RF receiver are used to process the RF signal.

5. The signal transceiver according to claim 1, wherein the first selection unit comprises:
a plurality of transmitting switch assemblies each of which is coupled between a first signal transmitting terminal of the signal transmitting terminals and a second signal transmitting terminal of the RF front-end circuit and used to set the conduction condition between the the first signal transmitting terminal and the second signal transmitting terminal of the RF front-end circuit according to the operating band of the wireless communication device; and
a plurality of receiving switch assemblies each of which is coupled between a first signal receiving terminal of the signal receiving terminals and a second signal receiving terminal of the RF front-end circuit and used to set the conduction condition between the first signal receiving terminal and the second signal receiving terminal of the RF front-end circuit according to the operating band of the wireless communication device.

6. The signal transceiver according to claim 1, wherein the second selection unit comprises a plurality of switch assemblies each of which is coupled between a first duplex transmission terminal of the duplex transmission terminals and a second duplex transmission terminal of the RF front-end circuit and used to set the conduction condition between the first duplex transmission terminal and the second duplex transmission terminal according to the operating band of the wireless communication device.

7. The signal transceiver according to claim 1, wherein the wireless communication device is a mobile phone.

8. A signal transceiver for a wireless communication device, comprising:
an antenna module;
a radio frequency (RF) transceiver including a plurality of signal transmitting terminals and a plurality of signal receiving terminals, wherein the RF transceiver is used to generate or process a RF signal via the signal transmitting terminals and the signal receiving terminals;
a RF front-end circuit coupled to the antenna module and for processing the RF signal; and
a selection unit coupled between the RF transceiver and the RF front-end circuit and used to select a signal transmitting terminal from the signal transmitting terminals and a signal receiving terminal from the signal receiving terminals to couple to the RF front-end circuit according to the operating band of the wireless communication device.

9. The signal transceiver according to claim 8, wherein the antenna module comprises:
an antenna; and
an antenna switch module (ASM) coupled between the antenna and the RF front-end circuit, including a plurality of duplex transmission terminals and used to select a duplex transmission terminal from the duplex transmission terminals to couple to the antenna according to the operating band of the wireless communication device.

10. The signal transceiver according to claim 9, wherein the RF front-end circuit is coupled to the duplex transmission terminals.

11. The signal transceiver according to claim 8, wherein the RF front-end circuit comprises:
a first signal transmitting terminal;
a first signal receiving terminal;
a duplex transmission terminal;
a duplexer coupled to the duplex transmission terminal;
a RF transmitter coupled between the first signal transmitting terminal and the duplexer; and
a RF receiver coupled between the first signal receiving terminal and the duplexer.

12. The signal transceiver according to claim 11, wherein the RF transmitter and the RF receiver are used to process the RF signal.

13. The signal transceiver according to claim 8, wherein the selection unit comprises:
a plurality of transmitting switch assemblies each of which is coupled between a first signal transmitting terminal of the signal transmitting terminals and a second signal transmitting terminal of the RF front-end circuit and used to set the conduction condition between the signal transmitting terminal and the signal transmitting terminal of the RF front-end circuit according to the operating band of the wireless communication device; and
a plurality of receiving switch assemblies each of which is coupled between a first signal receiving terminal of the signal receiving terminals and a second signal receiving terminal of the RF front-end circuit and used to set the conduction condition between the first signal receiving terminal and the second signal receiving terminal of the RF front-end circuit according to the operating band of the wireless communication device.

14. The signal transceiver according to claim 8, wherein the wireless communication device is a mobile phone.

15. A signal transceiver for a wireless communication device, comprising:
an antenna switch module (ASM) including a plurality of duplex transmission terminals;
a radio frequency (RF) transceiver including a plurality of signal transmitting terminals and a plurality of signal receiving terminals, wherein the RF transceiver is used to generate or process a RF signal via the signal transmitting terminals and the signal receiving terminals;
a RF front-end circuit for processing the RF signal; and
a selection unit coupled between the RF transceiver and the RF front-end circuit and used to select a duplex transmission terminal from the duplex transmitting terminals to couple the duplex transmission terminal to the RF front-end circuit according to the operating band of the wireless communication device.

16. The signal transceiver according to claim 15, wherein a signal transmitting terminal of the RF front-end circuit is coupled to the signal transmitting terminals of the RF transceiver.

17. The signal transceiver according to claim 15, wherein a signal receiving terminal of the RF front-end circuit is coupled to the signal receiving terminals of the RF transceiver.

18. The signal transceiver according to claim 15, wherein the RF front-end circuit comprises:
a first signal transmitting terminal;
a first signal receiving terminal;
a duplex transmission terminal;
a duplexer coupled to the duplex transmission terminal;
a RF transmitter coupled between the first signal transmitting terminal and the duplexer; and
a RF receiver coupled between the first signal receiving terminal and the duplexer.

19. The signal transceiver according to claim 18, wherein the RF transmitter and the RF receiver are used to process the RF signal.

20. The signal transceiver according to claim 15, wherein the selection unit comprises a plurality of switch assemblies each of which is coupled between one duplex transmission terminal of the duplex transmission terminals and one duplex transmission terminal of the RF front-end circuit and used to set the conduction condition between the duplex transmission terminal and the duplex transmission terminal of the RF front-end circuit according to the operating band of the wireless communication device.
